(19) United States
(12) Patent Application Publication
(10) Pub. No.: US 2026/0326833 A1
(43) Pub. Date: Oct. 22, 2026

(54) CARGO BODY CONSTRUCTION

(71) Applicant: STI Holdings, Inc., Stoughton, WI (US)

(72) Inventors: Todd Randall Eicher, Monticello, WI (US); Scott Lubenow, Fitchburg, WI (US)

(21) Appl. No.: 19/556,768

(22) Filed: Mar. 4, 2026

Related U.S. Application Data
(60) Provisional application No. 63/768,709, filed on Mar. 7, 2025.

(51) Int. Cl. B62D 33/04; B62D 27/02; B62D 29/00; B62D 29/04; B62D 53/06

(52) U.S. Cl. CPC B62D 33/046; B62D 27/026; B62D 29/008; B62D 29/045; B62D 53/06

(57) ABSTRACT

A cargo body sandwich panel includes a plurality of layered sheets including an exterior sheet, an interior sheet, and an interstitial sheet situated between the exterior sheet and the interior sheet. The cargo body sandwich panel further includes a plurality of cores including a first core situated between the exterior sheet and the interstitial sheet and a second core situated between the interstitial sheet and the interior sheet. The first core has a higher density than the second core and a smaller thickness than the second core. The second core has a lower coefficient of thermal conduction than the first core.

### CROSS-REFERENCE TO RELATED APPLICATIONS

This application claims the benefit of priority to co-pending U.S. Provisional Patent Application No. 63/768,709, filed Mar. 7, 2025, the entire contents of which are incorporated by reference herein.

### BACKGROUND

The present disclosure relates to cargo body construction, for example, for over-the-road trailers pulled by semi tractors. A trailer sidewall is often constructed from a number of panels joined together at joints (e.g., vertical post joints, lap joints, or splice plates). Aspects of the present disclosure relate to jointless sidewall construction. Aspects of the present disclosure relate to structural joints formed at a longitudinal rail provided at an upper or lower edge of the sidewall.

### SUMMARY

In some aspects, the present disclosure provides a cargo body sandwich panel includes a plurality of layered sheets including an exterior sheet, an interior sheet, and an interstitial sheet situated between the exterior sheet and the interior sheet. The cargo body sandwich panel further includes a plurality of cores including a first core situated between the exterior sheet and the interstitial sheet and a second core situated between the interstitial sheet and the interior sheet. The first core has a higher density than the second core and a smaller thickness than the second core. The second core has a lower coefficient of thermal conduction than the first core.

In some aspects, the present disclosure provides a cargo body including the cargo body sandwich panel. A floor structure of the cargo body supports a load floor of a cargo area. An outer lower rail of the cargo body extends along a length of a bottom edge of the cargo body sandwich panel. An inner lower rail of the cargo body extends along an interior side of the outer lower rail. At the bottom edge of the cargo body sandwich panel, the exterior sheet, the first core, and the interstitial sheet are captured between the outer lower rail and the inner lower rail. A lower portion of the exterior sheet is captured between the outer lower rail and the inner lower rail.

In some aspects, the present disclosure provides a cargo body including a sidewall provided by a sandwich panel having an exterior sheet, a first core inboard of the exterior sheet, an interstitial sheet inboard of the first core, a second core inboard of the interstitial sheet, and an interior sheet inboard of the second core. A floor structure of the cargo body supports a load floor of a cargo area. An outer lower rail of the cargo body extends along a length of a bottom edge of the sandwich panel. An inner lower rail of the cargo body extends along an interior side of the outer lower rail. At the bottom edge of the cargo body sandwich panel, the exterior sheet, the first core, and the interstitial sheet are captured between the outer lower rail and the inner lower rail. A lower portion of the exterior sheet extends beyond the first core and the interstitial sheet and is captured between the outer lower rail and the inner lower rail.

### BRIEF DESCRIPTION OF THE DRAWINGS

FIG. 1 is a side elevation view of a trailer, according to one construction of the present disclosure.

FIG. 2 is cross-section view of a lower portion of the trailer of FIG. 1, taken along line 2—2.

FIG. 3 is cross-section view of an upper portion of the trailer of FIG. 1, taken along line 3—3.

### DETAILED DESCRIPTION

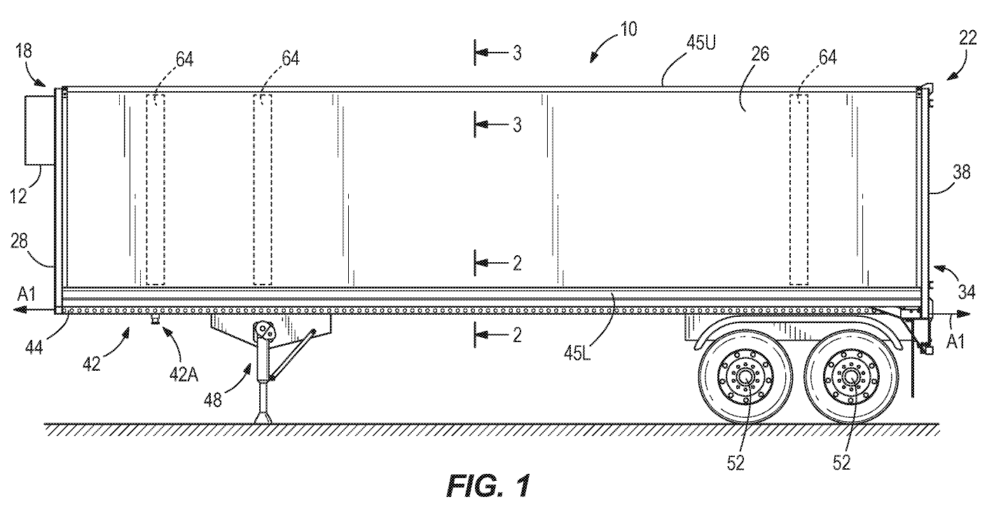

FIG. 1 illustrates a cargo body 10, such as an enclosed over-the-road commercial transport semi-trailer. In particular, the cargo body 10 can be a temperature-controlled, e.g., refrigerated or “reefer” cargo body. As such, the cargo body 10 can include or have attached thereto a temperature control unit (e.g., including a refrigeration system) 12. In other constructions, the cargo body can be configured as a dry van or another type of known cargo body, such as a straight truck rather than a detachable trailer. For the remaining description, the cargo body is referred to as the trailer 10 as it relates to the illustrated embodiment, with the understanding that this is not limiting. The interior of the trailer 10 defines a cargo area configured to contain and transport a load of cargo when the trailer 10 is in use. The trailer 10 and the interior cargo area thereof can be generally in the shape of a rectangular prism. The trailer 10 has a front or leading end 18 and a rear or trailing end 22. A longitudinal axis A1 of the trailer 10 extends between the front end 18 and the rear end 22 and is positioned centrally within the trailer 10 (e.g., forms a centerline thereof) to define a lengthwise or longitudinal direction of the trailer 10. The trailer 10 can have a length of 53 feet in some constructions. An opening 34 is positioned at the rear end 22 to allow for loading and unloading of cargo, and a door 38 is coupled to the opening 34 to selectively close the opening 34. A coupler assembly 42 is disposed at a bottom portion 44 of the front end 18 of the trailer 10 and allows a tractor or other truck (not shown) to selectively attach to the trailer 10. The coupler assembly 42 is centered in the trailer 10 such that the longitudinal axis A1 is also a central longitudinal axis of the coupler assembly 42. As will be understood, the coupler assembly 42 of the illustrated embodiment includes the kingpin 42A and is integrated into the floor structure of the trailer 10 to provide the necessary strength to transmit loads from the tractor to the trailer 10. For reference, U.S. Patent Application Publication No. 2024/0326933 of STI Holdings discloses an exemplary coupler assembly, the entire contents of which is incorporated by reference herein, although the trailer 10 can have any suitable coupler.

The trailer 10 includes two lengthwise sidewalls 26, one of which is shown in FIG. 1. The lengthwise sidewalls 26 are spaced apart in a widthwise direction of the trailer 10. Each of the lengthwise sidewalls 26 spans the length of the trailer 10, from the front end 18 to the rear end 22. An additional wall 28 at the front end 18 faces the front or leading direction and spans between the two primary lengthwise sidewalls 26. All of the walls 26, 28 span vertically between a lower rail 45L at the height of a floor structure of the trailer 10 and an upper rail 45U at a height of a roof of the trailer 10.

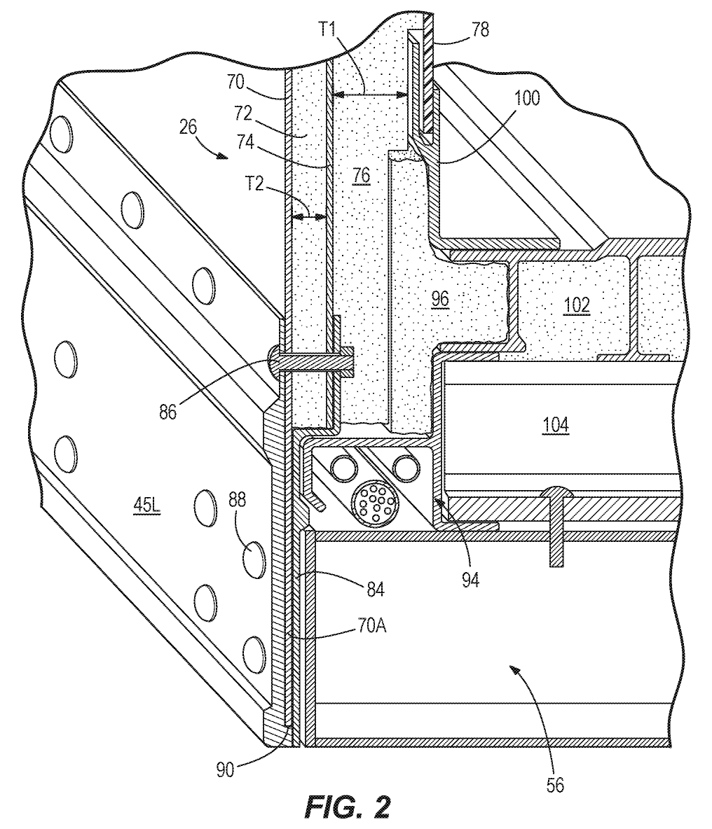

Generally adjacent the coupler assembly 42 in the front half of the trailer 10, the trailer 10 includes a set of landing gear 48 configured to selectively deploy downward and engage the ground or pavement to support the trailer 10 in a relatively horizontal orientation when decoupled from the tractor. Toward the rear of the trailer 10, one or more wheeled axles 52 are provided and supported by a suspension assembly (not shown). The landing gear 48 and suspension assembly can take any reasonable form, conventional or later developed, and both generally extend downwardly from the floor structure of the trailer 10. Aspects of the floor structure, the landing gear 48, and/or the suspension assembly can be similar to those disclosed in U.S. Patent Application Publication No. 2024/0391288 of STI Holdings, without limit thereto. The floor structure of the trailer 10 includes a plurality of support beams or cross-members 56, one of which is shown in FIG. 2. The cross-members 56 are elongated in the widthwise direction of the trailer 10. The cross-members 56 span between and couple together first and second (roadside and curbside) lower rails 45L.

In some constructions, each of the primary lengthwise sidewalls 26 can be constructed as a full-length, full height unitary panel, without any joints (i.e., jointless). In other words, there are not a plurality of smaller modular panels joined edge-to-edge to build up the full length of the trailer 10. The panel is manufactured to the full size of the sidewall 26. As described further below, the sidewall 26 can be a multi-layer composite sandwich panel. At one or more predetermined locations along the trailer length, the sidewall 26 can optionally be reinforced with a post 64. Examples of the post locations are shown in broken lines in FIG. 1. These include any one or more of the following lengthwise positions: at the coupler assembly 42, at the landing gear 48, or at the wheeled axles 52. The posts 64 can be integrated into the structure of the sidewalls 26 (e.g., recessed) without interrupting the lengthwise continuity of the sidewall 26.

FIG. 2 illustrates a bottom portion of an exemplary composite construction of the sidewall 26 of the trailer 10. FIG. 2 can be considered to disclose the roadside sidewall shown in FIG. 1 with the understanding that the curbside sidewall on the opposite widthwise side of the trailer 10 can have the same construction, in mirror image.

The sidewall 26 is manufactured as a sandwich panel having a layered construction. The sidewall 26 can be constructed to include an exterior sheet or skin 70, a first or exterior core layer 72, an interstitial sheet or skin 74, a second or interior core layer 76, and an interior sheet or skin 78. As illustrated, the exterior sheet 70 forms an exterior surface of the trailer 10. Likewise, the interior sheet 78 forms an interior cargo-facing surface or liner of the trailer 10. The interstitial sheet 74 may be exposed to neither the exterior nor the interior of the trailer 10, but rather buried or hidden on the interior of the sidewall 26. The interstitial sheet 74 may be situated nearer the exterior sheet 70 than the interior sheet 78. The sheets 70, 74, 78 can include sheets of one, two, or three materials. In other words, all the sheets 70, 74, 78 can be constructed of the same material, or one of the sheets 70, 74, 78 can have a material different from one or both of the other sheets 70, 74, 78. Likewise, the cores 72, 76 can include cores of one same material or two different materials. Regardless of the materials being heterogeneous or homogeneous, one or more of the sheets of the exterior, interstitial, and interior sheets 70, 74, 78 can have a thickness different than one or more of the others. Likewise, the cores 72, 76, regardless of their material construction, may have thicknesses that are the same or different.

In a first exemplary embodiment, the exterior sheet 70 and the interstitial sheet 74 can be constructed of glass-reinforced thermoplastic. Between the exterior sheet 70 and the interstitial sheet 74, the exterior core 72 can be constructed of foamed thermoplastic. The exterior sheet 70, the exterior core 72, and the interstitial sheet 74 make up a structural portion of the sidewall 26. The interior core 76 and the interior sheet 78 do not contribute meaningfully to the structural rigidity of the sidewall 26. In some cases, the sidewall 26 is configured to meet structural standards for the trailer 10 without the interior core 76 and the interior skin 78. The interior core 76 can be constructed of a material (e.g., foamed polyurethane) having a density less than a density of the exterior core 72. The interior core 76 can have a lower coefficient of thermal conduction than the exterior core 72. The interior core 76 can have a thickness T1 that exceeds a thickness T2 of the exterior core 72 (e.g., T1/T2 = 1.5 or greater). The thicknesses T1, T2 can be the predominant thickness that is present through a majority of the respective component, if there is thickness variation therein. The exterior core thickness T2 being less than the interior core thickness T1 helps keep the weight of the sidewall 26 down, as the density of the exterior core 72 can be substantially higher (e.g., 2x or greater) than the density of the interior core 76. The insulation properties of the sidewall 26 can be primarily provided by the interior core 76.

In some constructions, one, two or all three of the exterior sheet 70, the interior sheet 78, and the interstitial sheet 74 is constructed of aluminum. In some constructions, one, two, or all three of the exterior sheet 70, the interior sheet 78, and the interstitial sheet 74 are steel. In some constructions, the exterior core 72 can be foamed polystyrene. It should also be understood that various combinations of the disclosed materials can be used in other constructions within the scope of the present disclosure, as can other materials not mentioned explicitly here.

As shown in FIG. 2, the exterior sheet 70, the exterior core 72, and the interstitial sheet 74 are all situated between an inner lower rail 84 and the lower rail 45L, which can also be referred to as the outer lower rail. Once secured during assembly, the exterior sheet 70, the exterior core 72, and the interstitial sheet 74 have respective lower portions that are captured between the inner lower rail 84 and the lower rail 45L. The inner lower rail 84 and the outer lower rail 45L can have the same or similar heights and vertical span and provide a lower rail assembly. The inner lower rail 84 and/or the outer lower rail 45L can be formed as extrusions (e.g., aluminum). The outer lower rail 45L can be bonded to the exterior sheet 70 with structural adhesive. FIG. 2 also illustrates that the exterior sheet 70, the exterior core 72, and the interstitial sheet 74 are all clamped together between the outer lower rail 45L and the inner lower rail 84 by mechanical fasteners 86 (e.g., rivets, bolts, etc.). Below the bottom edge of the exterior core 72 and the interstitial sheet 74, the exterior sheet 70 further extends downward to form a tail portion 70A situated between the outer lower rail 45L and the inner lower rail 84. The inner lower rail 84 has offset upper and lower clamping portions. The inner lower rail 84 can be secured (e.g., bonded) to the inboard face of the exterior sheet 70 with structural adhesive. FIG. 2 also illustrates that the exterior sheet 70 is clamped between the outer lower rail 45L and the inner lower rail 84, and thus further secured, by mechanical fasteners 88 (e.g., rivets). The fasteners 88 can extend through an end plate or bracket of the crossmembers 56 so as to cooperate with the outer lower rail 45L to clamp the tail portion 70A and the inner lower rail 84 therebetween. The exterior sheet 70 can extend nearly or completely to the bottom edges of the outer lower rail 45L and/or the inner lower rail 84. In the illustrated construction, the outer lower rail 45L includes an interior ledge 90 on the interior side at its bottom edge, and the ledge supports and/or covers a bottom edge of the exterior sheet 70.

Vertically between the bottom of the sidewall 26 (dismissing the tail portion 70A) and the floor crossmembers 56, and inboard of the inner lower rail 84, the cargo body 10 includes a hollow channel or raceway (“wire chase”) 94 configured to receive one or more utility lines (e.g., air and/or electrical lines). Vertically above the raceway 94 and inboard of the interior core 76, the cargo body 10 includes a filler core 96. The filler core 96 has a T-shaped cross-section as illustrated. The filler core 96 abuts a floor flashing 100, a floor (e.g., composite floor panel) 102, and a subfloor insulation layer 104. The floor flashing 100 is generally L-shaped, having a vertical portion extending along the sidewall 26 and a horizontal portion extending along a top surface of the floor 102. An upper end of the floor flashing 100 can define an upwardly-opening channel in which a bottom edge of the interior sheet 78 is received.

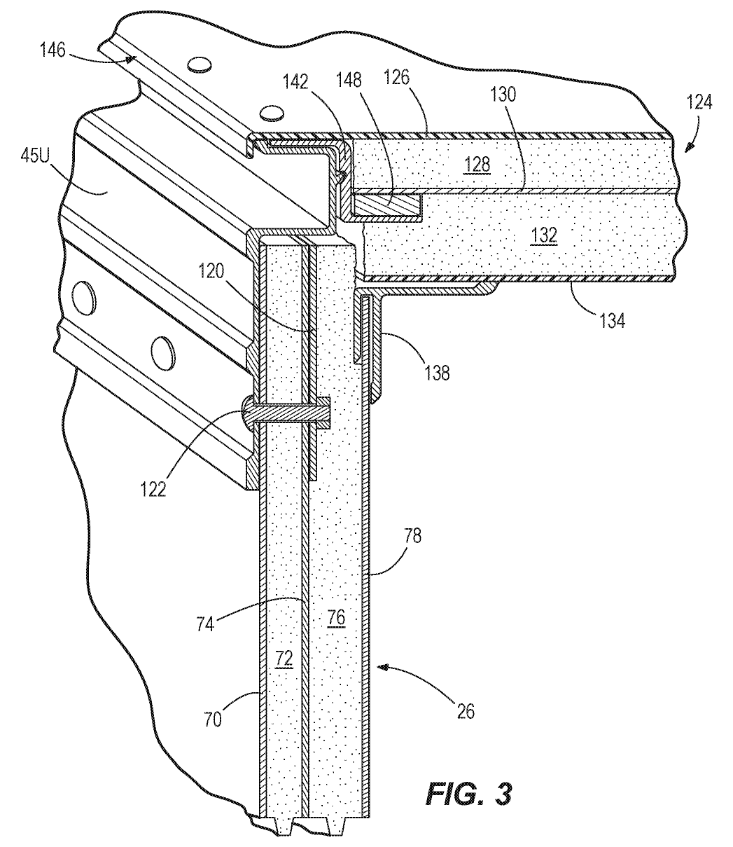

At an upper edge of the sidewall 26 (FIG. 3), an upper rail assembly is provided by the outer upper rail 45U and an inner upper rail 120. The exterior sheet 70, the exterior core 72, and the interstitial sheet 74 are all situated between the inner upper rail 120 and the outer upper rail 45U. The inner upper rail 120 has a common vertical span with a lower (flat) portion of the outer upper rail 45U. The inner upper rail 120 and/or the outer upper rail 45U can be formed as extrusions (e.g., aluminum). The outer upper rail 45U can be bonded to the exterior sheet 70 with structural adhesive. FIG. 3 also illustrates that the exterior sheet 70, the exterior core 72, and the interstitial sheet 74 are all clamped together between the outer upper rail 45U and the inner upper rail 120 by mechanical fasteners 122 (e.g., rivets, bolts, etc.). Above the lower portion of the outer upper rail 45U, an upper portion has a C-shaped profile, which is open toward the outboard side. The C-shaped upper portion of the outer upper rail 45U extends over the top edges of the exterior sheet 70, the exterior core 72, the interstitial sheet 74, the inner upper rail 120. As illustrated, the C-shaped upper portion of the outer upper rail 45U also extends over the top edge of at least a portion of the interior core 76. The C-shaped upper portion of the outer upper rail 45U is in line with the roof panel 124.

The roof panel 124 can be a sandwich panel of multiple layers. In some constructions, the roof panel 124 can have a construction similar to that of the sidewalls 26 with respect to the number of layers and/or materials. In some constructions, the roof panel 124 has an identical construction to the sidewalls 26, although the dimensions can vary from those of the sidewalls 26. The roof panel 124 includes an exterior sheet or skin 126, a first or exterior core 128, an interstitial sheet or skin 130, a second or interior core 132, and an inner sheet or skin 134. As illustrated, the exterior sheet 126 forms an exterior surface of the trailer 10. Likewise, the interior sheet 134 forms an interior cargo-facing surface or liner of the trailer 10. At the joint between the sidewall 26 and the roof panel 124, the trailer 10 includes a roof flashing 138. The roof flashing 138 is generally L-shaped, having a vertical portion extending along the sidewall 26 and a horizontal portion extending along the roof panel 124. A top edge of the interior sheet 78 is received into a downwardly-opening channel in the roof flashing 138.

To minimize or eliminate load from the weight of the roof panel 124 being applied to the roof flashing 138 and the interior sheet 78 of the sidewall 26, the upper rail assembly includes an inward-extending roof support ledge, which in the illustrated construction is provided by an additional inner upper rail 142 or “roof support bracket.” The roof support bracket 142 is positioned above the inner upper rail 120 and to the inboard side of the C-shaped upper portion of the outer upper rail 45U. The roof support bracket 142 has a Z-shaped profile (e.g., with two 90-degree bends). An outboard portion of the roof support bracket 142 is positioned between a horizontally extending upper edge of the outer upper rail 45U and an outboard edge portion of the exterior sheet 126 of the roof panel 124. However, as seen in FIG. 3, the outboard edge portion of the exterior sheet 126 turns downwardly around the upper edge of the outer upper rail 45U, forming a “hem” 146. This hem 146 helps control water flow, avoiding ingress of water. The hem 146 can be formed by thermoforming the exterior sheet 126. The outboard edge portion of the exterior sheet 126 and the upper edge of the outer upper rail 45U can be bonded together and/or coupled with mechanical fasteners (e.g., rivets, bolts, etc.). On an inboard portion of the roof support bracket 142, a spacer 148 can be provided. An interior surface of the interstitial sheet 130 can be supported by the spacer 148.

One or more of the insulating core layers (i.e., sidewall interior cores 76 or the roof interior core 132) can be formed by injection of the core material into a void formed between the adjacent sheets. For example, at the time of constructing the trailer 10, prior to final assembly of the upper and/or lower rail assemblies, the core material can be injected into empty space between the corresponding sheets.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. Various features of the invention are set forth in the following claims.

What is claimed is:

1. A cargo body sandwich panel comprising:
a plurality of layered sheets including an exterior sheet, an interior sheet, and an interstitial sheet situated between the exterior sheet and the interior sheet; and
a plurality of cores including a first core situated between the exterior sheet and the interstitial sheet and a second core situated between the interstitial sheet and the interior sheet,
wherein the first core has a higher density than the second core and a smaller thickness than the second core, and
wherein the second core has a lower coefficient of thermal conduction than the first core.

2. The cargo body sandwich panel of claim 1, wherein the exterior sheet, the interior sheet, and the interstitial sheet are all thinner than the first core and the second core, and the exterior sheet, the interior sheet, and the interstitial sheet all have a higher density than the first core and the second core.

3. The cargo body sandwich panel of claim 1, wherein the cargo body sandwich panel is manufactured as a complete jointless sidewall for a cargo body having a length of 53 feet.

4. The cargo body sandwich panel of claim 1, wherein a bottom edge of the exterior sheet extends past a bottom edge of the first core and past a bottom edge of the interstitial sheet.

5. The cargo body sandwich panel of claim 1, wherein the first core is foamed thermoplastic.

6. The cargo body sandwich panel of claim 1, wherein the second core is foamed polyurethane.

7. The cargo body sandwich panel of claim 1, wherein one, two, or all three of the exterior sheet, the interior sheet, and the interstitial sheet are glass-reinforced thermoplastic.

8. The cargo body sandwich panel of claim 1, wherein one, two, or all three of the exterior sheet, the interior sheet, and the interstitial sheet are aluminum.

9. The cargo body sandwich panel of claim 1, wherein one, two, or all three of the exterior sheet, the interior sheet, and the interstitial sheet are steel.

10. The cargo body sandwich panel of claim 1, wherein, throughout a majority of the cargo body sandwich panel, the interstitial sheet is the only sheet layer between the exterior sheet and the interior sheet and the first and second cores are the only core layers between the exterior sheet and the interior sheet.

11. A cargo body comprising:
the cargo body sandwich panel of claim 1;
a floor structure supporting a load floor of a cargo area;
an outer lower rail extending along a length of a bottom edge of the cargo body sandwich panel; and
an inner lower rail extending along an interior side of the outer lower rail,
wherein, at the bottom edge of the cargo body sandwich panel, the exterior sheet, the first core, and the interstitial sheet are captured between the outer lower rail and the inner lower rail,
wherein a lower portion of the exterior sheet is captured between the outer lower rail and the inner lower rail.

12. The cargo body of claim 11, wherein each of the exterior sheet, the interstitial sheet, and the interior sheet is provided in a single, continuous piece spanning substantially a full length of the cargo body.

13. A cargo body comprising:
a sidewall provided by a sandwich panel having an exterior sheet, a first core inboard of the exterior sheet, an interstitial sheet inboard of the first core, a second core inboard of the interstitial sheet, and an interior sheet inboard of the second core;
a floor structure supporting a load floor of a cargo area;
an outer lower rail extending along a length of a bottom edge of the sandwich panel; and
an inner lower rail extending along an interior side of the outer lower rail,
wherein, at the bottom edge of the cargo body sandwich panel, the exterior sheet, the first core, and the interstitial sheet are captured between the outer lower rail and the inner lower rail,
wherein a lower portion of the exterior sheet extends beyond the first core and the interstitial sheet and is captured between the outer lower rail and the inner lower rail.

14. The cargo body of claim 13, wherein the lower portion of the exterior sheet is secured between the outer lower rail and the inner lower rail with structural adhesive and a plurality of mechanical fasteners.

15. The cargo body of claim 13, wherein the sandwich panel extends continuously from a front end of the cargo body to a rear end of the cargo body.

16. The cargo body of claim 15, further comprising a coupler, landing gear, and a plurality of wheeled axles, wherein reinforcing posts for the sidewall are limited to respective locations of the coupler, the landing gear, and the wheeled axles.
